(19) United States
(12) Patent Application Publication
(10) Pub. No.: US 2025/0053455 A1
(43) Pub. Date: Feb. 13, 2025

(54) GENERALIZING COMPUTING TASKS FOR EXECUTION BY DISTRIBUTED LEDGER TECHNOLOGIES

(71) Applicant: Cisco Technology, Inc., San Jose, CA (US)

(72) Inventors: Joel A. Obstfeld, Hertfordshire (GB); Oliver James Bull, Bristol (GB); Louis Gwyn Samuel, Wiltshire (GB); Andrew Pletcher, Scotts Valley, CA (US); Luca Muscariello, Paris (FR)

(21) Appl. No.: 18/447,768

(22) Filed: Aug. 10, 2023

(51) Int. Cl. G06F 9/50

(52) U.S. Cl. CPC G06F 9/5038; G06F 9/5072

(57) ABSTRACT

A method, computer system, and computer program product are provided for generalizing computing tasks for execution by distributed ledger technologies. A request is obtained from a client device to execute a computing task, wherein the request includes one or more parameters for the computing task. One or more policy rules are obtained that indicate a plurality of computing services and selection criteria for the plurality of computing services, wherein the plurality of computing services include at least two different distributed ledger networks. One or more computing services are determined based on the one or more policy rules and the one or more parameters of the request. The request is provided to the one or more computing services to perform the computing task.

### TECHNICAL FIELD

The present disclosure relates generally to distributed ledger technologies, and more specifically, to generalizing computing for execution by distributed ledger technologies.

### BACKGROUND

Web3 is an idea for a new iteration of the World Wide Web which incorporates concepts such as decentralization, blockchain technologies, and token-based economics. In contrast to previous paradigms (e.g., Web 2.0), data and content are decentralized rather than stored in centralized databases or provided by centralized servers. Web3 technologies may include decentralized ledgers, smart contracts, decentralized storage solutions, and the like. However, as there are numerous different decentralized services, users may not possess the knowledge to select and interact with specific services.

### BRIEF DESCRIPTION OF THE DRAWINGS

FIG. 1 is a block diagram of a conceptual model for utilizing, supporting, and/or providing Web3 services, according to an example embodiment.

FIG. 2 is a block diagram depicting a distributed ledger for performing or supporting various operations in accordance with an embodiment of the present invention.

FIG. 3 is a block diagram of a computing environment for generalizing Web3 services, according to an example embodiment.

FIG. 3 is a flow chart of a method of alerting a user to high-priority communications, according to an example embodiment.

FIG. 4 is a block diagram of a computing environment for generalizing Web3 services, according to an example embodiment.

FIG. 5 is a flow chart of a method of executing computing tasks using distributed applications, according to an example embodiment.

FIG. 6 is a flow chart of a method of training and applying a selection model, according to an example embodiment.

FIG. 7 is a block diagram of a device that may be configured to perform operations to enable prioritizing of network traffic, as presented herein.

### DETAILED DESCRIPTION

### Overview

According to one embodiment, techniques are provided for generalizing computing tasks for execution by distributed ledger technologies. A request is obtained from a client device to execute a computing task, wherein the request includes one or more parameters for the computing task. One or more policy rules are obtained that indicate a plurality of computing services and selection criteria for the plurality of computing services, wherein the plurality of computing services include at least two different distributed ledger networks. One or more computing services are determined based on the one or more policy rules and the one or more parameters of the request. The request is provided to the one or more computing services to perform the computing task.

### Example Embodiments

Present embodiments relate to distributed ledger and Web3 technologies, and more specifically, to generalizing computing for execution by distributed ledger technologies. Distributed ledger technologies are built over a network of collaborating decentralized contribution nodes. Generally, these nodes are incentivized to both contribute and operate in accordance with protocol rules by being rewarded with token holdings, which are limited or otherwise managed in supply. The rules by which contribution nodes operate may be codified into the collaboration protocols, making the nodes self-operating. In order to access computing services provided by contribution nodes, access method procedures may be defined, which may involve signed transactions, action receipts, and the like. These services can be run and operated by third parties who manage access control via existing centralized (e.g., “Web2”) methods, which may involve infrastructure and tooling. This approach involves a detailed understanding of how to interact with Web3 services, as well as the use of centralized platforms. When multiple Web3 services are utilized for a given computing task, then each service may have its own contribution nodes, with its own set of infrastructure and operational aspects. This creates a significant burden with respect to contribution node setup, operation, and maintenance, as well as detailed knowledge of each of the services that a user desires to leverage.

To address this problem, the embodiments presented herein provide an improved approach for generalizing the execution of computing tasks using distributed applications. In particular, logic is provided to analyze a request to perform a computing task and identify particular computing services (e.g., distributed applications) that are suitable for executing the computing task. Moreover, the various protocols and access aspects for executing computing tasks using distributed ledgers can be implemented automatically to adapt a request for a given computing task so that it is able to be executed on any selected computing service. Thus, present embodiments improve the technical field of distributed computing by enabling client devices to perform computing tasks without having knowledge of specific distributed ledger technologies, including knowledge of which technologies are suitable for the task and how to communicate with those technologies. Present embodiments provide the practical application of generalizing access method procedures to greatly simplify the use of Web3 services by non-Web3 aware entities. By automatically selecting the appropriate specific Web3 services for a given task, the execution of the task is configured to provide improvements such as faster processing, faster consensus achievement, reduced consumption of computing resources (e.g., by selecting a computing service that satisfies a computing task rather than a different computing service that would achieve the same results at the cost of using greater resources), and generally improving the efficiency of Web3 operations.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

The term “Web3” denotes a collection of technologies and network models that collectively provide a decentralized approach in contrast to the prevailing centralized model of systems and solutions. In a centralized model, services are provided at the discretion of a single administrative entity. Conversely, in a decentralized model, services are delivered through the collaborative efforts of various administrative entities without a singular point of ownership or control. The primary objective of Web3 is to facilitate the creation of services composed of logical infrastructure offered by diverse administrative entities.

In such an environment, a set of technologies is used to establish trust and assurance concerning the operation and execution of services. This entails fostering trust and assurance among administrative entities offering logical infrastructure, as well as ensuring trust and assurance for the users of the resulting services. This set of technologies may encompass distributed ledgers, consensus mechanisms, payment methods for service exchanges, decentralized protocols, and smart contracts. These technologies work in tandem to enable the development of applications and services.

In a Web3 paradigm, distributed ledger technology (DLT) may be employed to provide various services. DLT may be an append-only distributed data structure that includes authenticity and integrity features in which updates (inserts) are accepted via a consensus mechanism among validators. Validators may refer to blockchain contribution operators that run a block consensus protocol. Blockchains refer to a type of DLT wherein the underlying data structure includes a hash chain of blocks of data. Contribution nodes are a component of a distributed ledger that provide compute, storage, and/or bandwidth services for running a DLT, blockchain, or other decentralized service. In DLT, contribution tokens may be a unit of value bound to the action of contributing to a peer-to-peer network running the DLT or blockchain; value tokens may store value and can be traded as assets. In the context of Web3, a smart contract may include a computer program that is configured to automatically execute, control, or document relevant events and actions according to the terms of a contract or agreement. A DLT may implement smart contracts by including a state machine that can be updated via DLT updates. A DLT may interface with one or more oracles, which are independent entities that provide information into and/or out of the smart contracts; oracles may also validate state and results. A decentralized application (dApp) may run on a blockchain, using a DLT to store state, and can utilize smart contract technology. Thus, a dApp is distributed in the sense that a dApp does not use a single central server as a service core.

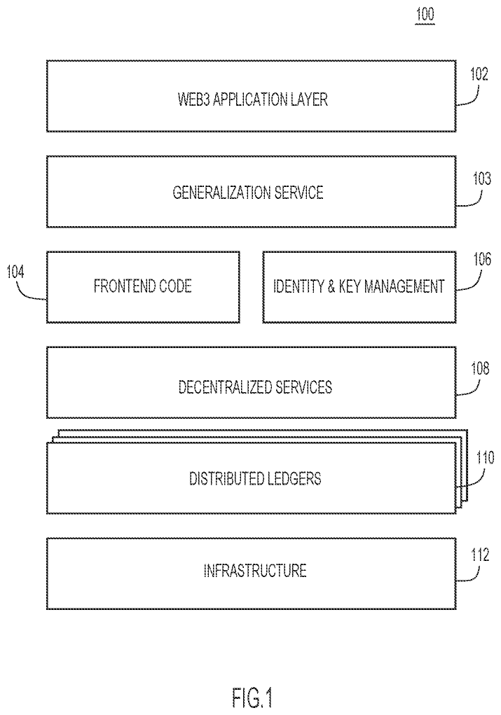

Embodiments will now be described in detail with reference to the Figures. Reference is now made to FIG. 1. FIG. 1 is a block diagram of a Web3 environment 100 for utilizing, supporting, and/or providing Web3 services, according to an example embodiment.

Web3 environment 100 has various layers, including a Web3 application layer 102, a generalization service 103, a frontend code layer 104, an identity and key management layer 106, a decentralized services layer 108, a distributed ledger layer 110, and an infrastructure layer 112. It should be appreciated that these layers are examples that are provided for the sake of clarity, and may not indicate any particular network topology.

Web3 application layer 102 may include one or more Web3 services that provide utility to end-users. These Web3 services may encompass a wide range of user experiences, use cases, and applications that leverage the benefits of decentralized technologies, and may not be limited to strictly Web3 environments. Some of the prominent use cases and applications may include multi-player games, virtual meeting environments, online collaboration tools, social media platforms, collectibles, augmented reality applications, virtual reality applications, cryptocurrency platforms, and the like. It is important to note that while these experiences and use cases can be facilitated by Web3 technologies, they are not exclusively dependent on Web3 and can be implemented in other contexts as well.

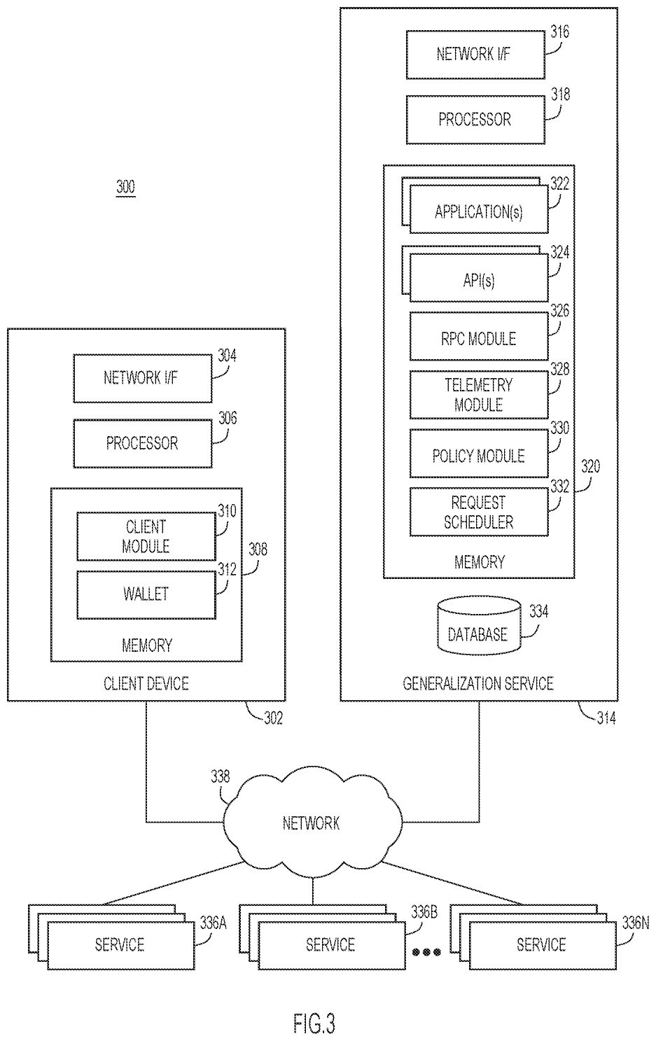

Generalization service 103 may perform operations in accordance with present embodiments that relate to the execution of decentralized applications, which may occur via one or more decentralized services of decentralized services layer 108 and/or one or more distributed ledgers of distributed ledger layer 110. Generalization service 103 is depicted and described in further detail with reference to FIG. 3.

Frontend code layer 104 for Web3 applications may refer to the application code that runs on client devices, enabling the user interface and interaction with decentralized services. This code can use various languages, such as JavaScript®, Hypertext Markup Language (HTML), and/or Cascading Style Sheets (CSS). Frontend code layer 104 can provide the functionality to interact with decentralized networks, access smart contracts, and handle user interactions. Frontend code layer 104 may include frameworks and libraries that can be utilized to build scalable and modular Web3 front-end applications (e.g., Web3 applications of Web3 application layer 102). In some embodiments, frontend code layer 104 provides the structure and content of Web pages, such as user interface elements, including text, buttons, forms, and containers. Frontend code layer 104 can be configured to provide any desired colors, fonts, layouts, and/or other visual properties of a user interface. Thus, frontend code layer 104 may enable the creation of dynamic and interactive user interfaces, facilitating the integration of decentralized functionality, and providing the particular user experience when interacting with Web3 services on client devices.

Identity and key management layer 106 provides an infrastructure for managing user identities, cryptographic keys, accounts, certificates, and signing operations within decentralized applications. Identity and key management layer 106 may ensure secure and reliable authentication, authorization, and cryptographic operations. In some embodiments, identity and key management layer 106 manages wallets, which are software applications that enable users to securely store and manage their cryptographic keys. These wallets typically employ strong encryption techniques to safeguard private keys and provide convenient interfaces for users to interact with their accounts and assets on decentralized networks. Identity and key management layer 106 may manage cryptographic keys, which are used for various purposes, including identity verification, digital signatures, encryption, and/or access control. Web3 identity systems often utilize public-key cryptography, where users possess a private key for signing transactions or providing proof of identity, and a corresponding public key for verification purposes. In some embodiments, identity and key management layer 106 manages Web3 accounts that are associated with specific identities or entities on decentralized networks. The accounts can be linked to cryptographic key pairs and may serve as the primary mechanism of interaction and ownership within the Web3 ecosystem. Accounts enable users to access and manage their assets, interact with smart contracts, and participate in network activities. Identity and key management layer 106 may manage certificates for enhancing trust and security. Certificates can serve as digital credentials that bind a user's identity to their cryptographic keys, enabling verification and validation of identities in decentralized environments. Certificates can be issued by trusted authorities or implemented through decentralized identity frameworks. In some embodiments, identity and key management layer 106 performs signing operations, which may involve using cryptographic keys to generate digital signatures. In Web3 environments, signing is used to ensure data integrity, non-repudiation, and/or secure transactions. By signing messages or transactions with their private keys, users can prove ownership and provide cryptographic proof of authenticity and integrity. Decentralized services layer 108 includes multiple disparate entities collaborating to offer various services. These services may include distributed document storage, tokenization, proof-of-existence, distributed computation-as-a-service, distributed communications-as-a-service, distributed ledger indexing and querying, and/or payment and exchange of value. Distributed document storage enables decentralized storage of files across a network of nodes, ensuring data availability and resilience. Tokenization represents real-world assets or rights as digital tokens, enabling fractional ownership and transferability. Proof-of-existence allows users to prove the integrity and timestamped existence of digital assets. Distributed computation-as-a-service may employ collective computational power for complex tasks, whereas distributed communications-as-a-service may facilitate secure and private communication without centralized intermediaries. Distributed ledger indexing and querying can provide access to data on distributed ledgers. Payment and exchange systems enable decentralized transactions using blockchain technology.

Distributed ledger layer 110 may employ one or more distributed ledgers that include various components and mechanisms to establish trust and assurance between entities in a decentralized environment. Distributed ledger layer 110 may include distributed ledger technologies, consensus mechanisms, layer 1 and layer 2 ledgers, rollups, zero-knowledge proofs, sharding, smart contract code, smart contract execution engines, contribution nodes, validator nodes, peer-to-peer (P2P) communications protocols, contribution tokens, and oracles. Distributed ledger technologies enable the decentralized storage and management of data across a network of nodes, and consensus mechanisms ensure agreement on the state of the ledger among participating nodes. Layer 1 features utilize methods such as changing the consensus mechanism, forking the chain, and sharding. In contrast, layer 2 services include state channels, nested blockchains, rollups, and sidechains. Rollups may aggregate and process transactions off-chain before committing the transactions to the main chain. Zero-knowledge proofs enable privacy-preserving and verifiable computations. Sharding elements partition the network into smaller groups, enhancing scalability. Smart contract code represents self-executing agreements on the ledger, while smart contract execution engines handle the processing and validation of these contracts. Distributed ledger layer 110 may include contribution nodes and validator nodes that maintain and secure the network. In some embodiments, peer to peer (P2P) communications protocols facilitate decentralized communication between nodes. Distributed ledger layer 110 utilizes contribution tokens to incentivize participation and contribution within the network. In some embodiments, distributed ledger layer 110 includes one or more oracles to provide external data and real-world information to smart contracts or other distributed applications. Nodes of distributed ledgers in distributed ledger layer 110 may emit broadcasts, during the course of execution of distributed applications, which include operation records, entity identities, and/or timestamps.

Infrastructure layer 112 may include a set of components that form the hardware and/or software that supports decentralized services and models, which may be substantially similar to those found in centralized systems. Infrastructure layer 112 can include compute resources, network infrastructure, telecommunications capabilities, bandwidth availability, processing capacity, hosting services, access mechanisms, security measures, and software frameworks. Compute resources may include the hardware and software for data processing and storage such as processor(s), microprocessor(s) and memory. Network infrastructure enables the connectivity and communication between nodes in the decentralized network, and other telecommunication elements may be responsible for the exchange of data and information across different network endpoints. Hosting services can support the deployment and management of decentralized applications and services. Access mechanisms may be provided to enable users to interact with the decentralized infrastructure of various components of Web3 environment 100 and its various services. Security measures may be provided to protect data, privacy, and network integrity. Software frameworks may provide the tools and libraries for developing and running Web3 applications in Web3 application layer 102 .

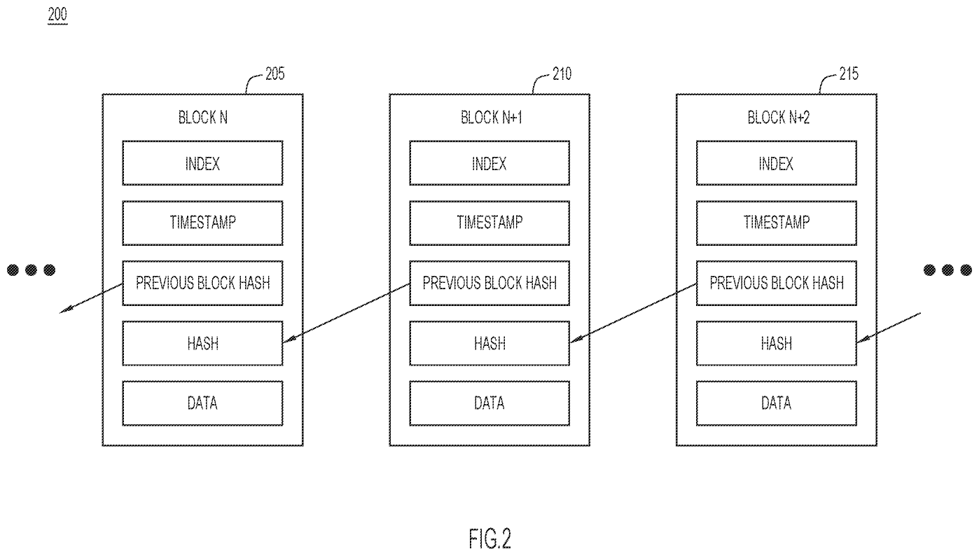

With reference now to FIG. 2, a block diagram is provided depicting a distributed ledger 200 for performing or supporting various operations in accordance with an embodiment of the present invention. As depicted, there are three blocks, block N (205), block N+1 (210), and block N+2 (215). It should be appreciated that this depiction of a distributed ledger 200 is only a portion of the ledger, and information can be stored as an entry in any block in distributed ledger 200. In some embodiments, distributed ledger 200 is a blockchain. Distributed ledger 200 may correspond to elements that are depicted and described with reference to distributed ledger layer 110 of FIG. 1.

Each block 205-215 may include an index, a timestamp, a previous block hash, a hash, and data. The index of a block includes an identifier for the block, such as a unique key. The timestamp of a block may indicate when the block was created, validated, and/or last modified. The previous block hash contains a hash of information in the previous block, which in turn capture, via their own hash, information in the next preceding block, ensuring that data recorded in distributed ledger 200 is immutable. In some embodiments, each hash may be a cryptographic hash, and may include a hash of the data stored in its block as well as the data corresponding to the previous block's hash. Thus, once recorded, the data in any given block cannot be altered retroactively without alteration of all subsequent blocks, which involves consensus of the network majority. The data can include any desired data, such as a transaction record, video data, text data, audio data, time-series data, encrypted data, data and corresponding metadata, and the like.

FIG. 3 is a block diagram in which a computing environment 300 is shown for generalizing Web3 services, according to an example embodiment. As depicted, computing environment 300 includes a client device 302, a generalization service 314, and a plurality of services 336A, 336B, . . . 336N that are in communication via a network 338. It is to be understood that the functional division among components have been chosen for purposes of explaining various embodiments and is not to be construed as a limiting example.

Client device 302 includes a network interface (I/F) 304, at least one processor (computer processor) 306, and memory 308, which stores instructions for a client module 310 and a wallet 312. In various embodiments, client device 302 may include a rack-mounted server, laptop, desktop, smartphone, tablet, or any other programmable electronic device capable of executing computer readable program instructions. Network interface 304 enables components of client device 302 to send and receive data over a network, such as network 338. It should be appreciated that there may be multiple client devices 302 as part of the computing environment 300; however, for simplicity, a single client device 302 is shown in the example embodiment of FIG. 1.

Client module 310 and/or wallet 312 may include one or more modules or units to perform various functions of the embodiments described below. Client module 310 and/or wallet 312 may be implemented by any combination of any quantity of software and/or hardware modules or units, and may reside within memory 308 of client device 302 for execution by a processor, such as processor 306.

Client module 310 may include any application that enables a user to access Web3 services, which can include decentralized applications (“dApps” such as smart contracts, etc.) decentralized storage services, cryptocurrency services, and the like. In some embodiments, client module 310 may additionally serve as a client for accessing other services, such as cloud-based storage services or other databases, cloud-based computational services, and the like. In various embodiments, client module 310 may enable users to manage their digital identities, interact with decentralized applications (e.g., using a wallet such as wallet 312), and/or otherwise manage digital assets. Thus, client module 310 can provide Web3 service integration by supporting connectivity to distributed ledger (e.g., blockchain) networks. In some embodiments, client module 310 may enable a user to access decentralized storage solutions in order to upload, store, and/or access data.

Client module 310 may thus support a variety of features that enables a user to utilize Web3 services. In various embodiments, a user may provide to client module 310 data regarding a user's desired parameters for executing computing tasks, which can include settings, configurations, and the like. For example, a user can stipulate a level of redundancy for storing data, a price range or maximum for using a service, a quality of service setting, service level agreement (SLA) requirements, and the like. In some embodiments, user settings or requirements may be automatically configured or suggested to a user based on previous user interactions. For example, a particular setting or requirement may automatically be implemented (optionally pending user confirmation) using a same setting or requirement that the user used during a previous use of a same or similar service.

Client module 310 may include a wallet management system to manage one or more wallets, such as wallet 312. Using client module 310, users can create and import wallets, store private keys or seed phrases, and interact with distributed ledger networks to send and receive digital tokens, including non-fungible tokens, digital currencies, and the like. Wallet 312 may include a software application or tool that enables a user to securely store, manage, and interact with their digital assets and/or other data, including tokens and other digital representations of value (e.g., compute tokens for offloading computing jobs to decentralized or cloud-based computing resources). Wallet 312 may employ cryptographic techniques to securely store private keys or seed phrases, which are used to access and control the user's digital assets (e.g., via client module 310). In some embodiments, wallet 312 may digitally sign transactions using a user's private key; the signed transactions can be broadcasted to a distributed ledger, enabling users to engage with decentralized services (e.g., executing smart contracts, etc.). Wallet 312 may include one or more addresses for receiving data, and/or wallet 312 may include one or more addresses corresponding to a unique identity of a user.

Generalization service 314 includes a network interface (I/F) 116, at least one processor 318, and memory 320, which stores instructions for one or more applications 322, one or more application programming interfaces (APIs) 124, a remote procedure call (RPC) module 326, a telemetry module 328, a policy module 330, and a request scheduler 332. Generalization service 314 may also include a database 334 and/or may access one or more other remote databases (not shown in FIG. 1). In various embodiments, generalization service 314 may include a rack-mounted server, laptop, desktop, smartphone, tablet, or any other programmable electronic device capable of executing computer readable program instructions. Network interface 316 enables components of generalization service 314 to send and receive data over a network, such as network 338. In general, generalization service 314 handles requests from remote computing devices (e.g., client device 302) to utilize Web3 or other services, and applies a policy to adapt the requests to automatically be directed to an appropriate service without the remote computing device necessarily being configured to communicate with that service.

Application(s) 322, API(s) 324, RPC module 326, telemetry module 328, policy module 330, and request scheduler 332 may include one or more modules or units to perform various functions of the embodiments described below. Application(s) 322, API(s) 324, RPC module 326, telemetry module 328, policy module 330, and request scheduler 332 may be implemented by any combination of any quantity of software and/or hardware modules or units, and may reside within memory 320 of generalization service 314 for execution by a processor, such as processor 318.

Application(s) 322 may each include a server-hosted application that facilitates the interaction between clients (e.g., client device 302, etc.) and one or more services (e.g., any of services 336A-336N, etc.), enabling the fulfillment of client requests by leveraging the capabilities of a particular service that is selected according to a policy. Generalization server may expose one or more APIs (e.g., API(s) 324) that allow clients to send requests and receive responses. These APIs 324 can utilize standard communication protocols, such as HTTP (Hypertext Transfer Protocol), WebSocket, or other appropriate protocols, to facilitate the transmission of data between clients and the server. Client applications (e.g., client module 310) may initiate requests by sending messages to generalization service 314 using one or more APIs 324. These requests may include operations like submitting transactions, querying data, uploading data, or executing specific actions on a distributed ledger.

RPC module 326 may facilitate interactions between applications 322 and services 336A-336N based on policies that are enforced by policy module 330. In particular, RPC module 326 may communicate with one or more services 336A-336N in order to perform actions related to a client request, including, but not limited to, retrieving data from a distributed ledger, providing data to a distributed ledger (e.g., recording a transaction), executing a distributed application, providing data to, or receiving data from, a database (e.g., cloud storage).

Telemetry module 328 may provide a telemetry layer for collecting and processing data relating to the performance, health, and/or any other desired data or metadata relating to the various components and/or services of computing environment 300. In particular, telemetry module 328 may gather and analyze operational data to enable monitoring of services 336A-336N and service selection by policy module 330. Telemetry module 328 can monitor nodes of any of services 336A-336N to obtain data, and telemetry module 328 can aggregate the data and store time-series data (e.g., in database 334) for historical purposes. Telemetry module 328 can perform real-time monitoring of services 336A-336N to detect the current state of each service. For example, telemetry module 328 can determine the status of a blockchain consensus algorithm, monitor block and transaction metrics (e.g., number of blocks mined, average block time, transaction throughput, transaction confirmation times, pending transaction count, etc.). Telemetry module 328 can determine node health and connectivity (e.g., node status (online or offline), node synchronization, node activity (e.g., participation in block validation or transaction processing). Telemetry module 328 can identify network latency and response time for services 336A-336N, and can identify security issues such as hash power distribution for proof-of-work blockchains, adherence to consensus rules, and other metrics. In some embodiments, telemetry module 328 can identify blockchain forks or chain reorganizations. Telemetry module 328 can also collect and analyze performance metrics for any of services 336A-336N that correspond to conventional servers, cloud-based platforms, and the like, such as computing resource availability and consumption (e.g., processing resource data, memory resource data, storage resource data, network bandwidth data, etc.), uptime, latency, and the like.

Policy module 330 may enforce policies that enable abstraction of client requests to utilize services (e.g., any of services 336A-336N) without requiring a client device to be configured to utilize any specific service. In particular, policy module 330 may analyze the intent of a client request, including the nature of the request, any user-defined constraints or requested parameters, and/or other data or metadata that may be relevant to selecting a particular service to fulfill the client's request. Policy module 330 can analyze a client request to determine the nature of the request, such as a request to access and/or provide data to a storage service, a non-fungible token service, a smart contract service, a video storage or playback service, and the like. In some embodiments, the user can indicate whether the user desires the service to be a decentralized ledger service or another type of service (e.g., a cloud-based service, a web-based service, etc.). In some embodiments, a user can specify constraints or parameters, such as a price range or a price maximum, a deadline, and the like.

When processing a client request, policy module 330 accesses a set of policies that enables policy module 330 to select one or more particular services of services 336A-336N that can satisfy the client request. The policies can indicate particular services that enable policy module 330 to perform selection of one or more services for a given request. The criteria may include prices, latency, throughput, deadlines, and the like, as well as the type of service requested, level of security/privacy, service level agreement, accessibility, and the like.

For example, a storage policy can indicate that if a request to store data is below a certain data size (e.g., one megabyte), and redundancy is desired, then the data should be stored to a distributed ledger, whereas if a request to store data is above a certain data size (e.g., one gigabyte), then another service should be used, such as a different distributed ledger, a decentralized storage service, or a cloud-based storage platform. As another example, based on the nature of a user request to process data, a policy can indicate whether a smart contract should be used vs. a cloud computing platform. for example, if the computing task involves conditional execution based on occurrence of an event, then a smart contract may be selected, whereas if the computing task involves processing without a condition, then a cloud computing platform may be selected. Policy module 330 may obtain policies from database 334, which can be updated with data about services 336A-336N via telemetry module 328 so that policy module 330 can rely upon up-to-date data in its decision logic.

In some embodiments, policy module 330 utilizes a multi-armed bandit approach when applying policies to select services. The multi-armed bandit logic may ensure that service selection achieves selection particular services among a set of multiple competing alternatives. In some embodiments, a one-state Markov decision process is utilized. In some embodiments, a zero-regret strategy may be employed. In some embodiments, one or more machine learning models are employed that are trained to make decisions by balancing the different options and exploiting the best-performing options based on currently available knowledge. A machine learning model may be provided with contextual information associated with each particular service, such as any features of the service, statuses of the service, and any other pertinent data about each service. An algorithm such as an epsilon-greedy, softmax, or upper confidence bound can be employed to balance exploration and exploitation of each service, and the machine learning algorithm can update its policies based on observed rewards for selected services and corresponding contextual information for each service. In some embodiments, reinforcement learning may be employed to adjust the probabilities of selection for each service. In some embodiments, the machine learning algorithm may be updated or retrained to automatically adjust weights or other parameters in response to receiving user feedback regarding whether a selected service was desirable or undesirable. Thus, the machine learning algorithm can continuously improve its accuracy over time using user feedback and by updating with recent data obtained by telemetry module 328.

Request scheduler 332 may receive user requests and indications of selected services for those requests in order to access the particular services and provide services with the user request for fulfillment by each service. Thus, request scheduler 332 includes logic for interacting with specific services, such as particular blockchains, servers, cloud services, and the like. For example, request scheduler 332 may include logic to access a server using a particular API in order to upload data included in the client request, and/or request scheduler 332 may include logic to write to a blockchain by communicating with a particular node or set of nodes to provide data from the client request in order to effect a transaction, execute a smart contract, and the like. Request scheduler 332 may include logic for scheduling events in order to cause actions to occur at particular times, including recurring times, predefined times, or in response to occurrence of a certain event or satisfaction of other criteria.

Services 336A-336N may include any computing services implemented by distributed ledger networks and/or other computing entities (e.g., cloud-based processing services, data centers, etc.). In various embodiments, services 336A-336N can include web-based services, cloud-based services, distributed ledgers (e.g., blockchain networks), and the like, and can provide any service, including data storage and/or retrieval, audio/video playback, compute job execution, transactions, database query execution, and the like.

Network 338 may include a local area network (LAN), a wide area network (WAN) such as the Internet, or a combination of the two, and includes wired, wireless, or fiber optic connections. In general, network 338 can be any combination of connections and protocols known in the art that will support communications between client device 302, generalization service 314, and/or services 336A-336N via their respective network interfaces in accordance with the described embodiments.

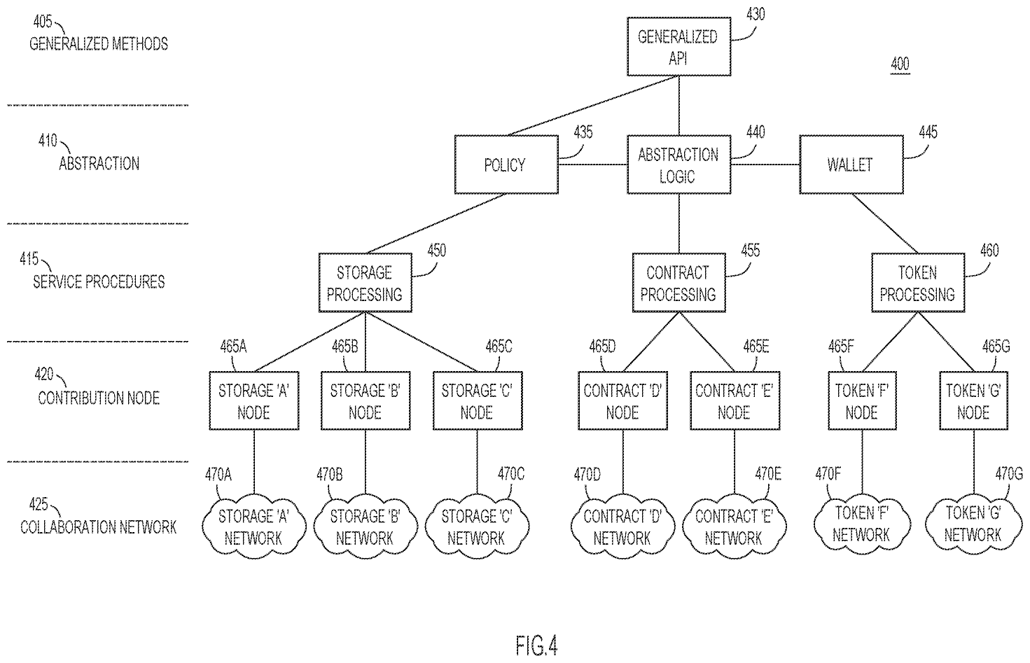

FIG. 4 is a block diagram of a computing environment 400 for generalizing Web3 services, according to an example embodiment. As depicted, computing environment 400 includes a generalized methods layer 405, an abstraction layer 410, a service procedures layer 415, a contribution node layer 420, and a collaboration network layer 425.

Generalized methods layer 405 may include one or more generalized APIs 430 for handling communications between various elements, including client devices (as depicted and described with reference to FIG. 3), servers, and/or distributed computing networks (e.g., networks 470A-470G). Generalized API(s) 430 may receive requests to perform computing tasks from client devices, which may not specify any particular distributed computing networks for completing the tasks, as the particular distributed computing networks may be selected according to policy 435 and/or abstraction logic 440.

Abstraction layer 410 may include policy 435, abstraction logic 440, and wallet 445. Policy 435 may include rules for selecting particular distributed computing networks to execute a computing task based on the type of task and parameters of the task. In the depicted example, the computing task may be a storage task, a smart contract task, or a token transfer task, and accordingly, policy 435 can indicate whether to select a storage distributed computing network (e.g., distributed computing networks 470A-470C), a smart contract distributed computing network (e.g., distributed computing networks 470D-470E), or a token transfer distributed computing network (e.g., distributed computing networks 470F-470G). moreover, policy 435 may include rules that select particular distributed computing networks based on parameters of the request, which can be defined by the user. The parameters can include a level of redundancy for storing data, a price range or maximum for using a service, a quality of service setting, service level agreement (SLA) requirements, and the like.

Abstraction logic 440 may include logic for generalizing requests to perform computing tasks by adapting a request to conform to the particular requirements of a selected distributed computing network, as well as logic for configuring the request to utilize the protocol of the selected distributed computing network. Abstraction logic 440 may be updated periodically in order to support new or modified distributed computing networks, such as forked networks. Wallet 445 may securely store tokens that are provided to distributed computing networks in order to authorize the execution of computing tasks.

Thus, when a request is processed according to policy 435 and abstraction logic 440, a service type (e.g., storage processing 450, contract processing 455, and/or token processing 460) is selected based on the type of request, and a specific distributed computing network 470A-470G. When one or more particular distributed computing networks of collaboration network layer 425 are selected, a particular contribution node 465A, 465B, 465C, 465D, 465E, 465F and 465G of contribution node layer 420 is accordingly selected, and the adapted request is provided to that contribution node. Once received by a contribution node, the corresponding distributed computing network is utilized to complete the computing task (e.g., any of storage networks 470A, 470B and 470C for a storage task, any of contract networks 470D and 470E for a smart contract task, and any of token networks 470F or 470G for a token transfer task). For example, Storage “A” Node 465A may utilize Storage “A” Network 470 to perform a storage computing task, as depicted.

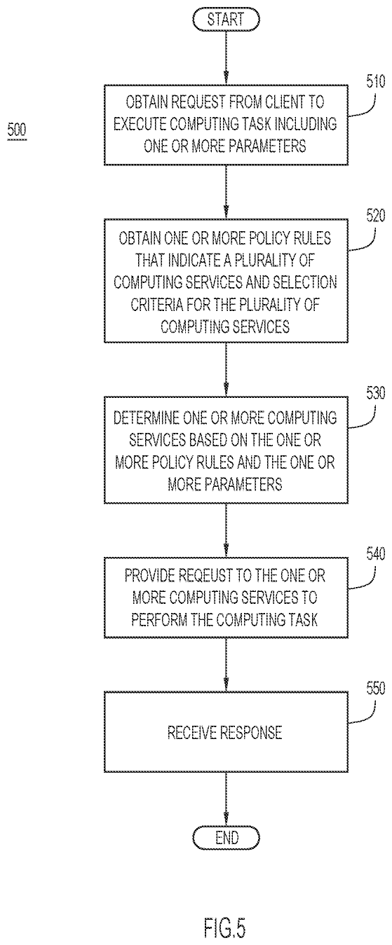

FIG. 5 is a flow chart of a method 500 of executing computing tasks using distributed applications, according to an example embodiment. Method 500 may be executed by a server, such as generalization service 314, which is depicted and described in further detail with reference to FIG. 3.

A request is received from a client device to execute a computing task at operation 510. The request may include data for processing or storage, and one or more parameters for performing the computing task. Additionally, a type of computing task may be indicated, such as a storage task, a processing task, a smart contract task, a token (e.g., fungible or non-fungible) transfer task, and the like. The parameters can indicate a level of redundancy for storing data, a price range or maximum for using a service, a quality of service setting, service level agreement (SLA) requirements, and the like.

Policy rules are obtained at operation 520. The policy rules can indicate selection criteria for particular distributed computing networks to execute the computing task. In particular, the policy rules can indicate which distributed computing network should execute the computing task based on its parameters. For a storage computing task, the policy rules may indicate a particular distributed computing network based on the size of data being stored, the requested availability of the data (e.g., how quickly the data can be provided or obtained), a level of redundancy of the data, a level of security of the storage platform, a duration of storage, and the like. For a smart contract task, the policy rules may indicate a particular smart contract application based on the nature of the smart contract being performed (e.g., the conditions that trigger execution of the contract), the type of tokens being used, and the like. Similarly, for a token transfer task, the policy rules may indicate a particular distributed computing network that processes the type of token (e.g., Ethereum, etc.). In some embodiments, the cost of utilizing a particular distributed computing network may be considered, and a user can indicate in the parameters a range of costs or a maximum cost. In some embodiments, computing services are selected based on a maturity of each service (e.g., an older service may be selected over a newer service). In some embodiments, a stability of each service may be considered (e.g., a service with less downtime may be preferentially selected over a service with higher downtime). In some embodiments, an availability of each service may be considered (e.g., a service that has greater availability, lower transaction times, and the like may be selected over a less-available service). Thus, one or more computing services are determined using the policy rules at operation 530.

The request is provided to the one or more computing services at operation 540. A contribution node of the one or more computing services may be selected, and the request may be adapted to be compatible with the protocols and/or any other aspects of the computing services. Thus, the computing task may be executed by the one or more computing services. In some embodiments, the computing task utilizes two or more different distributed ledgers, and accordingly, the computing task involves communication between those distributed ledgers.

A response is received from the one or more computing services at operation 550. The response may indicate a state of execution of the computing task. In various embodiments, the response can indicate whether the computing task has completed or has failed, and/or the response can include results of processing data according to the requested computing task. The response can be provided to the client device from which the request was received so that a user can be informed as to the results of the requested computing task. In some embodiments, performance of distributed computing services may be monitored over time to update the policy rules. For example, if a particular service fails at a computing task, or the task exceeds a threshold duration, then the policy rules can be updated to no longer utilize that service. Any performance data of computing services can be collected to adjust the policy rules in order to achieve selection of computing services and accordingly execution of computing tasks.

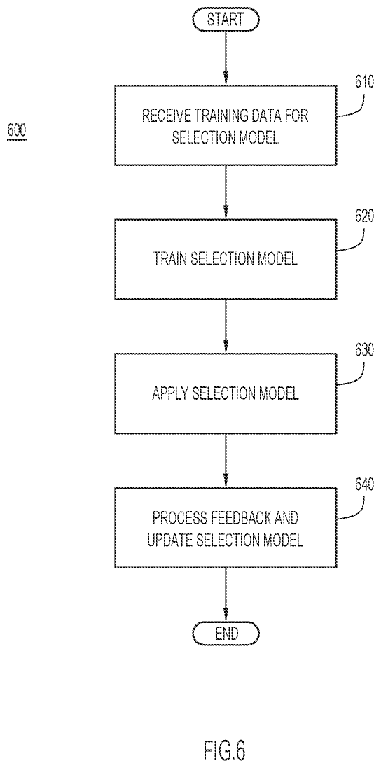

FIG. 6 is a flow chart of a method 600 of training and applying a selection model, according to an example embodiment.

Training data for the selection model is received at operation 610. Training data may include examples of requests for processing computing tasks, including parameters for the computing tasks, and corresponding distributed computing networks that are used to execute those processing tasks. The examples may be labeled to indicate various types of computing tasks, such as storage tasks, token transfer tasks, streaming tasks, inventory management computing tasks, smart contract computing tasks, and the like.

The selection model is trained at operation 620. The selection model may be a multi-armed bandit model or other machine learning model, such as a neural network model, a decision tree model, a random forest model, a reinforcement learning model, and the like. A portion of the training data may be reserved as testing data, and the selection model may be trained until the selection model attains a desired level of accuracy (which is determined using the testing data).

The selection model is applied at operation 630. Rather than user-defined policy rules, the selection model may be employed to select particular distributed computing networks for performing a given computing task. Data relating to the performance of the computing task may be obtained, such as whether the task was successful or failed, how long the computing task took to perform, and the like.

Feedback is processed and the selection model is updated at operation 640. Based on the performance of computing tasks that have been selected by the selection model, the selection model can be updated to the selection process over time. For example, if a particular distributed computing network tends to fail at a particular type of computing task, the selection model may be adjusted to be less likely to select that network for a same or similar computing task in the future.

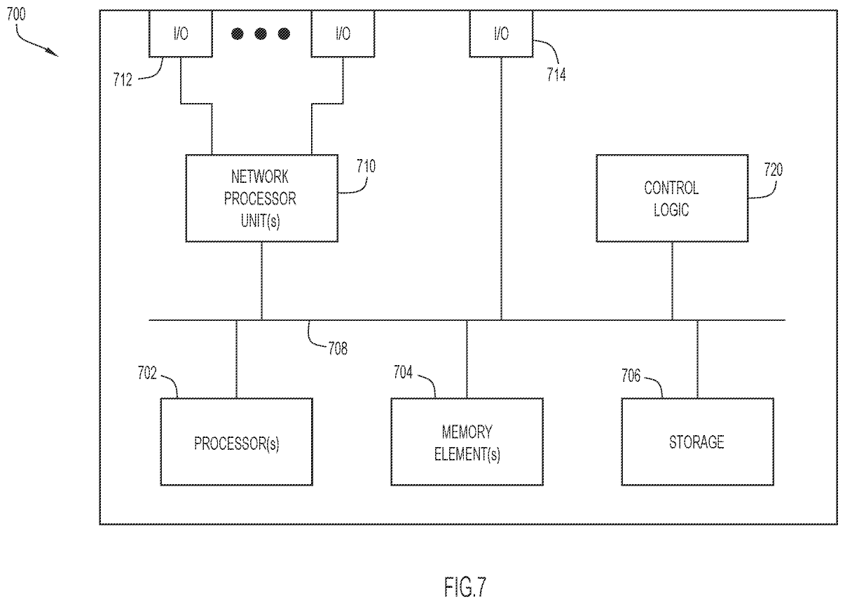

Referring now to FIG. 7, FIG. 7 illustrates a hardware block diagram of a computing device 700 that may perform functions associated with operations discussed herein in connection with the techniques depicted in FIGS. 1-6. In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O 714, and 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O 714 allow for input and output of data and/or information with other entities that may be connected to computing device 700. For example, I/O 714 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein.

Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

In some aspects, the techniques described herein relate to a computer-implemented method including: obtaining a request from a client device to execute a computing task, wherein the request includes one or more parameters for the computing task; obtaining one or more policy rules that indicate a plurality of computing services and selection criteria for the plurality of computing services, wherein the plurality of computing services include at least two different distributed ledger networks; determining one or more computing services based on the one or more policy rules and the one or more parameters of the request; and providing the request to the one or more computing services to perform the computing task.

In some aspects, the techniques described herein relate to a computer-implemented method, wherein the one or more computing services includes a distributed ledger, and further including: selecting a particular contribution node of the distributed ledger; providing the request to the particular contribution node; obtaining a response from the distributed ledger; and providing the response to the client device, wherein the response indicates a state of execution of the computing task.

In some aspects, the techniques described herein relate to a computer-implemented method, wherein the plurality of computing services are selected from a group of: a storage service, a smart contract service, a token transaction service, and an inventory management service.

In some aspects, the techniques described herein relate to a computer-implemented method, wherein the computing task includes a communication between the at least two different distributed ledger networks.

In some aspects, the techniques described herein relate to a computer-implemented method, further including: providing one or more application programming interfaces configured to transmit the request to the one or more computing services.

In some aspects, the techniques described herein relate to a computer-implemented method, further including: providing a selection model that determines the one or more computing services based the one or more parameters of the request and based on one or more of: a cost parameter of the one or more computing services, a maturity parameter of the one or more computing services, a stability parameter of the one or more computing services, and an availability parameter of the one or more computing services.

In some aspects, the techniques described herein relate to a computer-implemented method, wherein the selection model includes a multi-armed bandit model.

In some aspects, the techniques described herein relate to a computer-implemented method, wherein the selection model includes a machine learning model, and further including: training the machine learning model using training data including previous computing tasks executed by the plurality of computing services or other computing services.

In some aspects, the techniques described herein relate to a computer-implemented method, further including: updating the one or more policy rules based on monitoring the plurality of computing services.

In some aspects, the techniques described herein relate to a system including: one or more computer processors; one or more computer readable storage media; and program instructions stored on the one or more computer readable storage media for execution by at least one of the one or more computer processors, the program instructions including instructions to: obtain a request from a client device to execute a computing task, wherein the request includes one or more parameters for the computing task; obtain one or more policy rules that indicate a plurality of computing services and selection criteria for the plurality of computing services, wherein the plurality of computing services include at least two different distributed ledger networks; determine one or more computing services based on the one or more policy rules and the one or more parameters of the request; and provide the request to the one or more computing services to perform the computing task.

In some aspects, the techniques described herein relate to a system, wherein the one or more computing services includes a distributed ledger, and wherein the program instructions further include instructions to: select a particular contribution node of the distributed ledger; provide the request to the particular contribution node; obtain a response from the distributed ledger; and provide the response to the client device, wherein the response indicates a state of execution of the computing task.

In some aspects, the techniques described herein relate to a system, wherein the plurality of computing services are selected from a group of: a storage service, a smart contract service, a token transaction service, and an inventory management service.

In some aspects, the techniques described herein relate to a system, wherein the computing task includes a communication between the at least two different distributed ledger networks.

In some aspects, the techniques described herein relate to a system, wherein the program instructions further include instructions to: provide one or more application programming interfaces configured to transmit the request to the one or more computing services.

In some aspects, the techniques described herein relate to a system, wherein the program instructions further include instructions to: provide a selection model that determines the one or more computing services based the one or more parameters of the request and based on one or more of: a cost parameter of the one or more computing services, a maturity parameter of the one or more computing services, a stability parameter of the one or more computing services, and an availability parameter of the one or more computing services.

In some aspects, the techniques described herein relate to a system, wherein the selection model includes a machine learning model, and wherein the program instructions further include instructions to: train the machine learning model using training data including previous computing tasks executed by the plurality of computing services or other computing services.

In some aspects, the techniques described herein relate to one or more non-transitory computer readable storage media having program instructions embodied therewith, the program instructions executable by a computer to cause the computer to perform operations including: obtain a request from a client device to execute a computing task, wherein the request includes one or more parameters for the computing task; obtain one or more policy rules that indicate a plurality of computing services and selection criteria for the plurality of computing services, wherein the plurality of computing services include at least two different distributed ledger networks; determine one or more computing services based on the one or more policy rules and the one or more parameters of the request; and provide the request to the one or more computing services to perform the computing task.

In some aspects, the techniques described herein relate to one or more non-transitory computer readable storage media, wherein the one or more computing services includes a distributed ledger, and wherein the program instructions further cause the computer to: select a particular contribution node of the distributed ledger; provide the request to the particular contribution node; obtain a response from the distributed ledger; and provide the response to the client device, wherein the response indicates a state of execution of the computing task.

In some aspects, the techniques described herein relate to one or more non-transitory computer readable storage media, wherein the plurality of computing services are selected from a group of: a storage service, a smart contract service, a token transaction service, and an inventory management service.

In some aspects, the techniques described herein relate to one or more non-transitory computer readable storage media, wherein the computing task includes a communication between the at least two different distributed ledger networks.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining a request from a client device to execute a computing task, wherein the request includes one or more parameters for the computing task;
obtaining one or more policy rules that indicate a plurality of computing services and selection criteria for the plurality of computing services, wherein the plurality of computing services include at least two different distributed ledger networks;
determining one or more computing services based on the one or more policy rules and the one or more parameters of the request; and
providing the request to the one or more computing services to perform the computing task.

2. The computer-implemented method of claim 1, wherein the one or more computing services comprises a distributed ledger, and further comprising:
selecting a particular contribution node of the distributed ledger;
providing the request to the particular contribution node;
obtaining a response from the distributed ledger; and
providing the response to the client device, wherein the response indicates a state of execution of the computing task.

3. The computer-implemented method of claim 1, wherein the plurality of computing services are selected from a group of: a storage service, a smart contract service, a token transaction service, and an inventory management service.

4. The computer-implemented method of claim 1, wherein the computing task includes a communication between the at least two different distributed ledger networks.

5. The computer-implemented method of claim 1, further comprising:
providing one or more application programming interfaces configured to transmit the request to the one or more computing services.

6. The computer-implemented method of claim 1, further comprising:
providing a selection model that determines the one or more computing services based the one or more parameters of the request and based on one or more of: a cost parameter of the one or more computing services, a maturity parameter of the one or more computing services, a stability parameter of the one or more computing services, and an availability parameter of the one or more computing services.

7. The computer-implemented method of claim 6, wherein the selection model comprises a multi-armed bandit model.

8. The computer-implemented method of claim 6, wherein the selection model comprises a machine learning model, and further comprising:
training the machine learning model using training data including previous computing tasks executed by the plurality of computing services or other computing services.

9. The computer-implemented method of claim 1, further comprising:
updating the one or more policy rules based on monitoring the plurality of computing services.

10. A system comprising:
one or more computer processors;
one or more computer readable storage media; and
program instructions stored on the one or more computer readable storage media for execution by at least one of the one or more computer processors, the program instructions comprising instructions to:
obtain a request from a client device to execute a computing task, wherein the request includes one or more parameters for the computing task;
obtain one or more policy rules that indicate a plurality of computing services and selection criteria for the plurality of computing services, wherein the plurality of computing services include at least two different distributed ledger networks;
determine one or more computing services based on the one or more policy rules and the one or more parameters of the request; and
provide the request to the one or more computing services to perform the computing task.

11. The system of claim 10, wherein the one or more computing services comprises a distributed ledger, and wherein the program instructions further comprise instructions to:
select a particular contribution node of the distributed ledger;
provide the request to the particular contribution node;
obtain a response from the distributed ledger; and
provide the response to the client device, wherein the response indicates a state of execution of the computing task.

12. The system of claim 10, wherein the plurality of computing services are selected from a group of: a storage service, a smart contract service, a token transaction service, and an inventory management service.

13. The system of claim 10, wherein the computing task includes a communication between the at least two different distributed ledger networks.

14. The system of claim 10, wherein the program instructions further comprise instructions to:
provide one or more application programming interfaces configured to transmit the request to the one or more computing services.

15. The system of claim 10, wherein the program instructions further comprise instructions to:
provide a selection model that determines the one or more computing services based the one or more parameters of the request and based on one or more of: a cost parameter of the one or more computing services, a maturity parameter of the one or more computing services, a stability parameter of the one or more computing services, and an availability parameter of the one or more computing services.

16. The system of claim 15, wherein the selection model comprises a machine learning model, and wherein the program instructions further comprise instructions to:
train the machine learning model using training data including previous computing tasks executed by the plurality of computing services or other computing services.

17. One or more non-transitory computer readable storage media having program instructions embodied therewith, the program instructions executable by a computer to cause the computer to perform operations including:
obtain a request from a client device to execute a computing task, wherein the request includes one or more parameters for the computing task;
obtain one or more policy rules that indicate a plurality of computing services and selection criteria for the plurality of computing services, wherein the plurality of computing services include at least two different distributed ledger networks;
determine one or more computing services based on the one or more policy rules and the one or more parameters of the request; and
provide the request to the one or more computing services to perform the computing task.

18. The one or more non-transitory computer readable storage media of claim 17, wherein the one or more computing services comprises a distributed ledger, and wherein the program instructions further cause the computer to:
select a particular contribution node of the distributed ledger;
provide the request to the particular contribution node;
obtain a response from the distributed ledger; and
provide the response to the client device, wherein the response indicates a state of execution of the computing task.

19. The one or more non-transitory computer readable storage media of claim 17, wherein the plurality of computing services are selected from a group of: a storage service, a smart contract service, a token transaction service, and an inventory management service.

20. The one or more non-transitory computer readable storage media of claim 17, wherein the computing task includes a communication between the at least two different distributed ledger networks.
